(19) United States
(12) Patent Application Publication
(10) Pub. No.: US 2021/0375022 A1
(43) Pub. Date: Dec. 2, 2021

(54) ELECTRONIC DEVICE FOR PROVIDING ANIMATED IMAGE AND METHOD THEREFOR

(71) Applicant: Samsung Electronics Co., Ltd., Suwon-si (KR)

(72) Inventors: Shinjun LEE, Suwon-si (KR); Youngjoon OH, Suwon-si (KR); Chanmin PARK, Suwon-si (KR); Jungeun LEE, Suwon-si (KR)

(21) Appl. No.: 17/445,105

(22) Filed: Aug. 16, 2021

Related U.S. Application Data
(63) Continuation of application No. PCT/KR2020/001642, filed on Feb. 5, 2020.

(30) Foreign Application Priority Data
Feb. 18, 2019 (KR) 10-2019-0018626

(51) Int. Cl. G06T 13/40; H04N 5/272; G06T 17/10; H04N 5/265

(52) U.S. Cl. CPC G06T 13/40; H04N 5/265; G06T 17/10; H04N 5/272

(57) ABSTRACT

An electronic device includes a camera, a display, a processor that is operatively connected with the camera and the display, and a memory that is operatively connected with the processor and stores animation data associated with a motion. The memory stores instructions that, when executed, cause the processor to obtain, through the camera, an image associated with an external object, to generate a three-dimensional (3D) object for an avatar representing the external object, based on the obtained image, to display, through the display, a first two-dimensional (2D) image generated based on the animation data and the 3D object, to receive a first input of editing the 3D object, to generate a second 2D image in which an appearance of the avatar in the first 2D image is changed based on the first input thus received, and to display, through the display, the second 2D image.

### CROSS-REFERENCE TO RELATED APPLICATIONS

This application is a continuation of International Application No. PCT/KR2020/001642, filed Feb. 5, 2020, which claims priority to Korean Patent Application No. 10-2019-0018626, filed Feb. 18, 2019, the disclosures of which are herein incorporated by reference in their entirety.

### BACKGROUND

### 1. Field

Embodiments of the disclosure relate to an electronic device for providing an animated image and a method thereof.

### 2. Description of Related Art

An electronic device may recognize an appearance of a user (e.g., at least one of a face, a body, clothes, or an accessory of a user) by using a camera and may generate an avatar based on the recognized appearance of the user. The avatar may be referred to as “augmented reality (AR) emoji”. The electronic device may visually convey the user's emotional state, which cannot be transmitted by a text message, through an avatar that resembles the user's appearance, and may arouse the user's interest.

To convey the user's emotional state, the electronic device may generate an animated image by composing animation data, a background image, a text, or an effect image with an avatar. The animated image including the avatar may be referred to as an “emoji sticker”.

### SUMMARY

Users generally express diverse expressions of emotional states, which can be restricted based on a storage space of a memory in an electronic device. In the case where the electronic device provides an emoji sticker indicating specified motion, background, and effect, because an emoji sticker that the user wants can be absent, the electronic device may fail to satisfy the user needs. Also, increasing the number of emoji stickers indicating specified motions, backgrounds, and effects may increase the amount of data stored in the memory. On the contrary, in the case where the user makes use of only a specific emoji sticker(s), the efficiency of the storage space of the memory may decrease due to an increase of unnecessary emoji stickers.

Various embodiments of the disclosure may provide an electronic device for providing an animated image while solving the above-described problems and a method thereof.

According to an embodiment of the disclosure, an electronic device may include a camera, a display, a processor that is operatively connected with the camera and the display, and a memory that is operatively connected with the processor and stores animation data associated with a motion. The memory may store instructions that, when executed, cause the processor to obtain, through the camera, an image associated with an external object, to generate a three-dimensional (3D) object for an avatar representing the external object, based on the obtained image, to display, through the display, a first two-dimensional (2D) image generated based on the animation data and the 3D object, to receive a first input of editing the 3D object, to generate a second 2D image in which an appearance of the avatar in the first 2D image is changed based on the first input thus received, and to display, through the display, the second 2D image.

According to an embodiment of the disclosure, a method of an electronic device may include obtaining an image associated with an external object, generating a three-dimensional (3D) object for an avatar representing the external object, based on the obtained image, displaying a first two-dimensional (2D) image generated based on animation data stored in the electronic device and the 3D object, receiving a first input of editing the 3D object, and displaying a second 2D image in which at least a portion of the first 2D image is changed based on the first input thus received.

According to an embodiment of the disclosure, an electronic device may include a camera, a display, a processor that is operatively connected with the camera and the display, and a memory that is operatively connected with the processor and stores animation data associated with a motion. The memory may store instructions that, when executed, cause the processor to obtain, through the camera, an image associated with an external object, to generate a three-dimensional (3D) object for an avatar representing the external object, based on the obtained image, to generate a first 2D image indicating a motion of the avatar, based on the 3D object and the animation data, and to display the first 2D image through the display.

According to embodiments of the disclosure, an electronic device may provide an emoji sticker indicating emotional state that a user wants and may also improve the efficiency of a memory.

According to embodiments of the disclosure, by generating an emoji sticker of a specified format, the electronic device may improve the efficiency of the memory and may secure the compatibility with an external electronic device.

Besides, a variety of effects directly or indirectly understood through this disclosure may be provided.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of an electronic device in a network environment according to various embodiments.

FIG. 2 is a block diagram of an electronic device according to various embodiments.

FIG. 3 describes an operation of an electronic device displaying an animated image, according to various embodiments.

FIG. 4 illustrates an operating environment of a sticker composing module, according to various embodiments.

FIG. 5 illustrates an animated image including a plurality of frames, according to various embodiments.

FIG. 6 illustrates an operation environment of an electronic device composing images, according to various embodiments.

FIG. 7 illustrates a sampling operation environment, according to various embodiments.

FIG. 8 illustrates an operation flowchart of an electronic device displaying an animated image, according to various embodiments.

FIG. 9 describes an operating environment of an electronic device generating a second animated image, according to various embodiments.

FIG. 10 illustrates an operation flowchart of an electronic device generating second animated image, according to various embodiments.

FIG. 11 illustrates an operating environment of a sticker editing module, according to various embodiments.

FIG. 12 illustrates a user interface (UI) for editing an animated image, according to various embodiments.

FIG. 13 illustrates an operating environment of a sticker generating module, according to various embodiments.

FIG. 14 illustrates an UI for generating an animated image, according to various embodiments.

FIG. 15 illustrates an operating environment of a viewer module, according to various embodiments.

FIG. 16 illustrates an UI for displaying a thumbnail, according to various embodiments.

FIG. 17 illustrates an operating environment of an electronic device updating a thumbnail, according to various embodiments.

FIG. 18 illustrates an operating environment of an electronic device for sharing an animated image with any other application, according to various embodiments.

FIG. 19 illustrates an UI for sharing an animated image with a gallery application, according to various embodiments.

FIG. 20 illustrates an UI for sharing an animated image with a message application, according to various embodiments.

FIG. 21 illustrates an UI for sharing an animated image with a contact application, according to various embodiments.

FIG. 22 describes an operating environment of an electronic device generating an animated image when the animated image is not stored in a memory, according to various embodiments.

With regard to description of drawings, the same or similar components will be marked by the same or similar reference signs.

### DETAILED DESCRIPTION

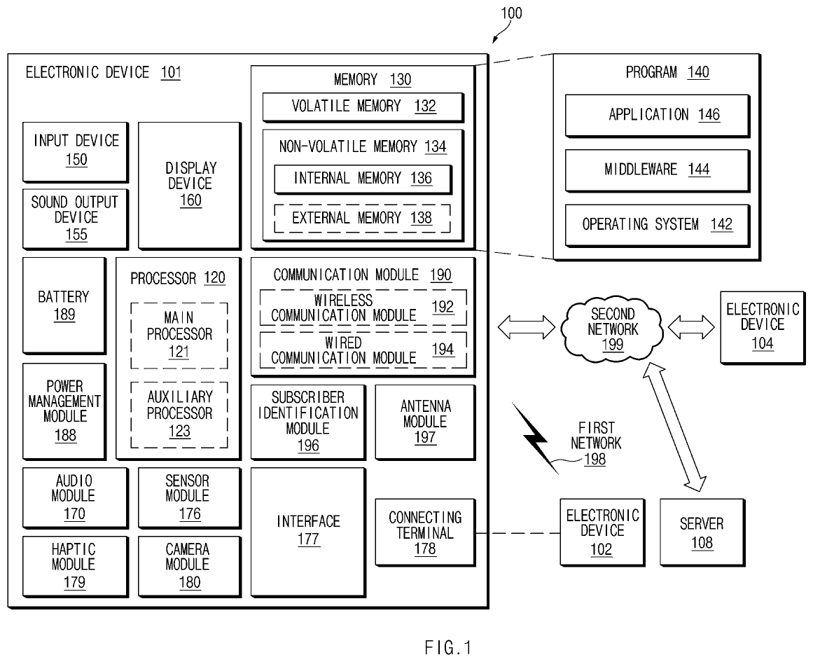

FIGS. 1 through 22, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, various embodiments of the disclosure will be described with reference to accompanying drawings. However, those of ordinary skill in the art will recognize that modification, equivalent, and/or alternative on various embodiments described herein can be variously made without departing from the scope and spirit of the disclosure.

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

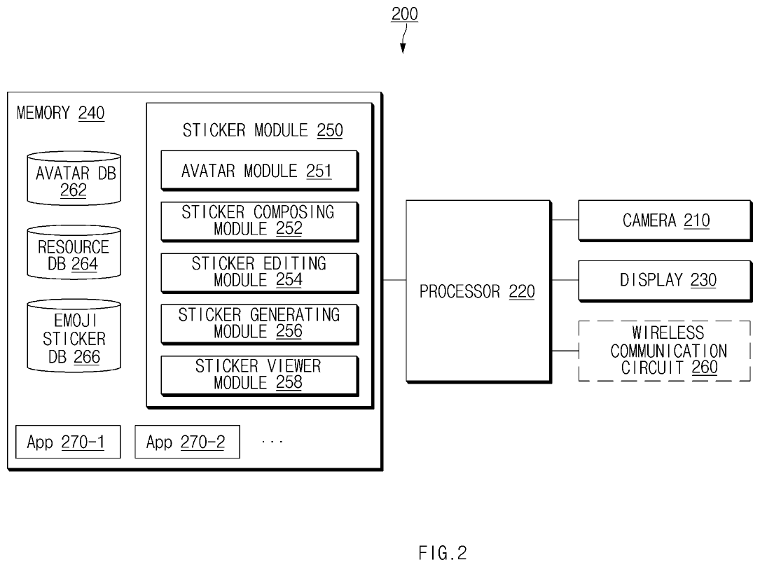

FIG. 2 is a block diagram 200 of the electronic device 101, according to various embodiments.

Referring to FIG. 2, the electronic device 101 may include a camera 210, a processor 220, a display 230, and a memory 240. The electronic device 101 may further include at least one of the components illustrated in FIG. 1, in addition to the components illustrated in FIG. 2.

According to an embodiment, the camera 210 may obtain an image of an external object (e.g., a user). The camera 210 may be at least part of the camera module 180 of FIG. 1.

According to an embodiment, the display 230 may output an animated image, or a screen including an UI for generating or editing the animated image. In the specification, an animated image may mean an image indicating a motion of an avatar. An animated image may be referred to as an “emoji sticker” or “sticker”. The display 230 may be at least part of the display device 160 of FIG. 1. The display 230 may include a sensor circuit configured to receive an input of the user.

According to an embodiment, the electronic device 101 may further include a wireless communication circuit 260 for the purpose of sharing an animated image with an external electronic device. The wireless communication circuit 260 may be at least part of the wireless communication module 192 of FIG. 1. The wireless communication circuit 260 may send an animated image to the external electronic device over wireless communication (e.g., the first network 198 or the second network 199 of FIG. 1).

According to an embodiment, the processor 220 may be operatively connected with the camera 210, the display 230, and the wireless communication circuit 260. The processor 220 may perform a function that is identical or similar to the function of the processor 120 of FIG. 1. According to an embodiment, the processor 220 may perform overall functions of the electronic device 101 for providing an animated image by executing instructions stored in the memory 240. For example, the processor 220 may obtain an image of an external object (e.g., the user) through the camera 210 and may generate a three-dimensional (3D) object for an avatar indicating an appearance of the external object (e.g., the user's face or body) based on the obtained image. The 3D object may be referred to as a “3D model”. For another example, the processor 220 may generate an animated image indicating a motion (or movement) of an avatar through a 3D object for the avatar, a sticker module 250 stored in the memory 240, and data stored in a data base (DB) (e.g., 262, 264, or 266). For another example, the processor 220 may display an animated image through the display 230 or may send the animated image to the external electronic device through the wireless communication circuit 260.

According to an embodiment, the memory 240 may be operatively connected with the processor 220 and may store instructions executable by the processor 220. The memory 240 may store the sticker module 250, a data base (e.g., 262, 264, or 266) storing data associated with an animated image, and at least one application (e.g., 270-1, 270-2 . . . ).

According to an embodiment, the sticker module 250 may perform functions for generating and managing an animated image. The sticker module 250 may include an avatar module 251, a sticker composing module 252, a sticker editing module 254, a sticker generating module 256, and a sticker viewer module 258. According to an embodiment, the sticker module 250 and modules (e.g., 251, 252, 254, 256, and 258) included in the sticker module may be individual software modules (e.g., the application 146 of FIG. 1) or may be an integrated software module.

According to an embodiment, the avatar module 251 may generate a 3D object for an avatar based on an image obtained through the camera 210. The avatar module 251 may diversely and detailedly express the user's appearance (e.g., a hair style, a face, a body, clothes, or an accessory) by generating an avatar, which resembles the user, as a 3D model (i.e., a 3D object). A file format of the 3D object may be, for example, “gITF” or “obj”. The avatar module 251 may store a 3D object or data associated with the 3D object in an avatar DB 262. The data associated with the 3D object may include, for example, at least one of a name of the 3D object (or a 3D avatar), identification information, 3D coordinates, a geometry, a topology, a texture image, or a texture coordinate.

According to an embodiment, the avatar module 251 may edit a 3D object or data associated with the 3D object depending on a user input. For example, the avatar module 251 may load a 3D object stored in the avatar DB 262 and may display the loaded 3D object to the user through the display 230. The avatar module 251 may receive a user input of editing an appearance (e.g., at least one of a hair style, a face, a body, clothes, or an accessory) of an avatar that a 3D avatar indicates and may edit the 3D object depending on the received input. For another example, the avatar module 251 may edit a name of an avatar depending on the user input.

According to an embodiment, the sticker composing module 252 may generate an animated image by composing the 3D object generated by the avatar module 251 and resource data stored in a resource DB 264. The resource data may include, for example, at least one of animation data indicating facial expression or body motion of an avatar, a foreground (FG) image, a background (BG) image, an effect image (or a decoration image), or a text.

To make the efficiency of the memory 240 high and the compatibility with an external electronic device or any other application high, the sticker composing module 252 may generate an animated image as a 2D image corresponding to a specified number of frames. For example, a file format of an animated image may be “GIF”, “AGIF”, or “MP4”. In the case where there is an application not supporting an animated image, the sticker composing module 252 may generate a still image by selecting one of a plurality of frames constituting the animated image. A file format of a still image may be, for example, “PNG” or “JPG”. According to an embodiment, the sticker composing module 252 may store an animated image in an emoji sticker DB 266.

According to an embodiment, the sticker editing module 254 may provide a function that allows the user to edit an animated image previously generated. For example, the sticker editing module 254 may load an animated image of a 2D format previously stored in the emoji sticker DB 266 and may load resource data stored in the resource DB 264. The sticker editing module 254 may provide an UI that allows the user to add a foreground, a background, an effect, or a text to the loaded animated image by using the resource data.

According to an embodiment, the sticker generating module 256 may provide a function that allows the user to generate a desired animated image. For example, the sticker generating module 256 may load resource data stored in the resource DB 264 and may output an UI that allows the user to select at least one of an avatar motion, a foreground, a background, an effect, or a text constituting the animated image.

According to an embodiment, the sticker viewer module 258 may provide an UI that allows the user to generate, edit, and share an animated image through the electronic device 101. For example, the sticker viewer module 258 may call the sticker composing module 252, the sticker editing module 254, or the sticker generating module 256 in response to a user input of generating or editing an animated image.

According to an embodiment, the sticker module 250 may provide an environment in which the user is capable of using an emoji sticker for various purposes, by sharing an animated image with any other application (e.g., 270-1, 270-2 . . . ). The other application may include, for example, a gallery application, a message application, a social network service (SNS) application, and a contact application.

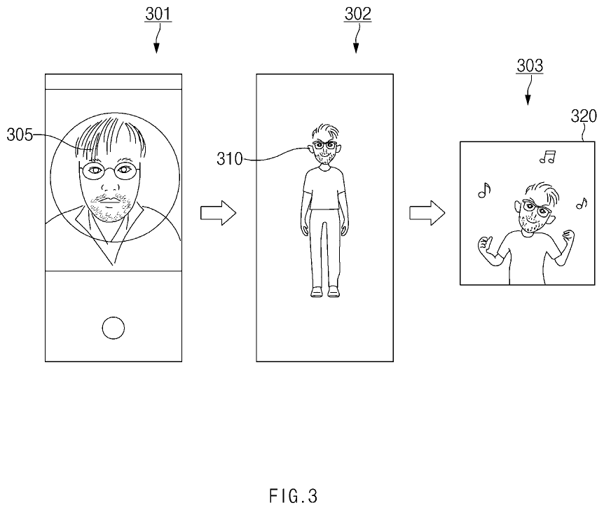

FIG. 3 describes an operation of the electronic device 101 displaying an animated image 320, according to various embodiments.

Referring to FIG. 3, in operation 301, the electronic device 101 may obtain an image associated with a user 305. For example, the electronic device 101 may execute a camera application and may obtain an image including a face of the user 305 through the camera 210.

In operation 302, the electronic device 101 may generate an avatar 310 indicating an appearance of the user 305 based on the obtained image. The electronic device 101 generates the avatar 310 in a 3D shape for the purpose of diversely and detailedly expressing the appearance of the user 305.

In operation 303, the electronic device 101 may generate the animated image 320 indicating a motion of the avatar 310 based on the generated 3D object and resource data stored in the resource DB 264. For example, the electronic device 101 may generate the animated image 320 by composing at least one of animation data, an FG image, a BG image, an effect image, or a text with the 3D object. The electronic device 101 may generate the animated image 320 in the format of a 2D image so as to secure a storage space of the memory 130 and sharing an image with an external electronic device more easily by reducing a size of a file.

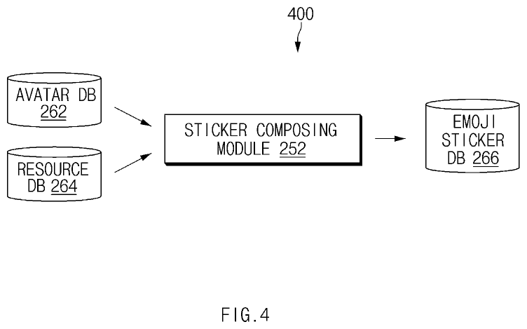

FIG. 4 illustrates an operating environment 400 of the sticker composing module 252, according to various embodiments.

Referring to FIG. 4, the sticker composing module 252 may load a 3D object and identification information about the 3D object stored in the avatar DB 262. The sticker composing module 252 may load resource data stored in the resource DB 264. The sticker composing module 252 may generate an animated image of a 2D image format by composing the loaded 3D object and resource data. According to an embodiment, the sticker composing module 252 may store the generated animated image in the emoji sticker DB 266.

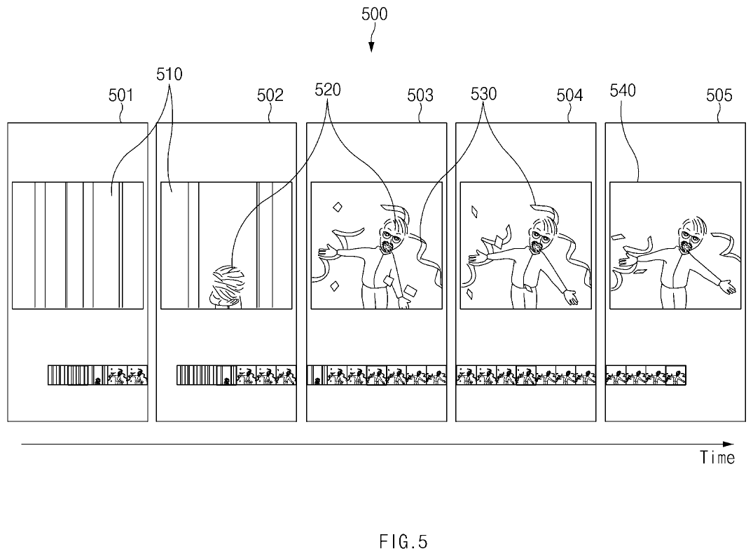

FIG. 5 illustrates an animated image 500 including a plurality of frames, according to various embodiments.

Referring to FIG. 5, the animated image 500 may include a plurality of frames. When the animated image 500 is reproduced by the electronic device 101, the electronic device 101 may provide, through the display 230, an effect that a foreground 510, an avatar 520, and an object 530 indicating an effect moves in process of time (e.g., from the left to the right) in a state where a background 540 does not move. For example, the electronic device 101 may generate the animated image 500 such that the foreground 510 moves from a first frame 501 to a third frame 503, the avatar 520 moves from a second frame 502 to the third frame 503, and the object 530 moves from the third frame 503 to a fifth frame 505.

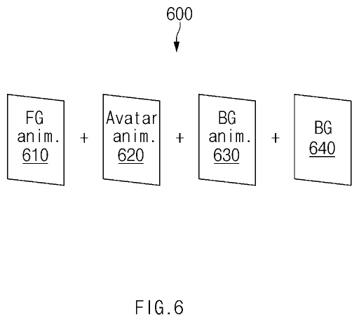

FIG. 6 illustrates an operating environment 600 of the electronic device 101 composing images, according to various embodiments.

Referring to FIG. 6, the electronic device 101 (e.g., the sticker composing module 252) may compose a plurality of images for each layer. The highest layer (i.e., the leftmost layer in FIG. 6) may be displayed at the very front on the display 230 with respect to the user, and the lowest layer (the rightmost layer in FIG. 6) may be displayed at the very back on the display 230 with respect to the user. The electronic device 101 may insert an FG image 610 in the highest layer, an avatar image 620 below the FG image 610, a deco image 630 (or an effect image) below the avatar image 620, and a BG image 640 in the lowest layer.

According to an embodiment, each of the FG image 610, the avatar image 620, and the deco image 630 may be a still image or may be an animated image including a plurality of frames. In this case, the electronic device 101 may generate a 2D frame by mapping images onto a 3D space based on data (e.g., 3D coordinates) associated with a 3D object and rendering the images mapped onto the 3D space in a 2D space.

According to an embodiment, because a size of a file increases in proportion to a resolution, the electronic device 101 may determine a resolution of an animated image based on a resolution of the display 230, or a resolution (e.g., 360×360 or 720×720) that an application (e.g., the application 270-1 or 270-2 of FIG. 2) supports.

According to an embodiment, because a black edge line can be viewed when a background image (e.g., 640) is black, the electronic device 101 may insert a white background image instead of a black background image. To maintain a transparent region, the electronic device 101 may remove the white background image after images are composed.

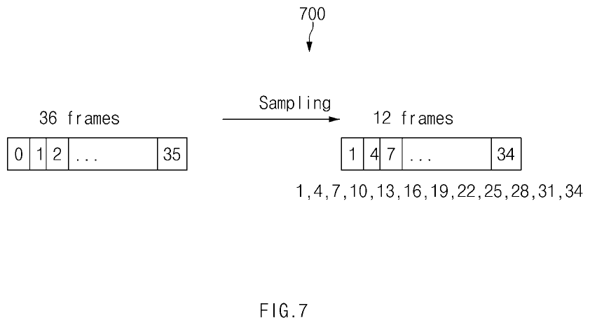

FIG. 7 illustrates a sampling operation environment 700, according to various embodiments.

Referring to FIG. 7, the electronic device 101 may generate an animated image based on a plurality of frames (e.g., 0, 1, 2 . . . 35). A file format of the plurality of frames may be, for example, “png”, “json”, “bvh”, or “gITF”.

According to an embodiment, the electronic device 101 may sample the plurality of frames based on securing of a storage space of the memory 130, compatibility with another application (e.g., the application 270-1 and 270-2 of FIG. 2), performance of the electronic device 101, performance of an external electronic device sharing an animated image with the electronic device 101, or a size of a data file allowable at a location (e.g., a country or a region) where a connection of the electronic device 101 is made. For example, the electronic device 101 may sample 36 frames to 12 frames. According to an embodiment, the electronic device 101 may sample frames at the same interval.

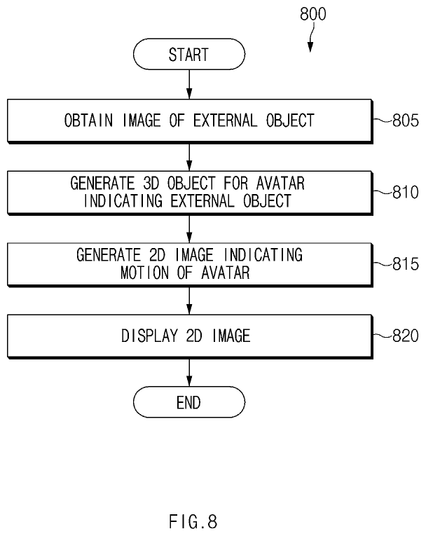

FIG. 8 illustrates an operation flowchart 800 of the electronic device 101 displaying an animated image, according to various embodiments. Operations illustrated in FIG. 8 may be performed as the processor 220 executes instructions stored in the memory 240.

Referring to FIG. 8, in operation 805, the processor 220 may obtain an image of an external object (e.g., the user) through the camera 210.

In operation 810, the processor 220 may generate a 3D object for an avatar indicating the external object based on the obtained image. For example, the processor 220 may generate the 3D object through the avatar module 251.

In operation 815, the processor 220 may generate a 2D image representing a motion of the avatar based on resource data stored in the memory 240 (e.g., the resource DB 264) and the 3D object. The 2D image may include an animated image. For example, the processor 220 may compose at least one of animation data, an FG image, a background image, an effect image, or a text, with the 3D object through the sticker composing module 252.

According to an embodiment, the processor 220 may generate the 2D image in plurality. For example, when there is a history that a 2D image is generated or edited depending on a user input, the processor 220 may generate a plurality of 2D images based on the history information stored in the memory 240.

In operation 820, the processor 220 may display the generated 2D image through the display 230. According to an embodiment, when the processor 220 generates a plurality of 2D images, the processor 220 may display thumbnails for the plurality of 2D images. In this case, the processor 220 may display the thumbnails in order based on the user's preference included in the history information.

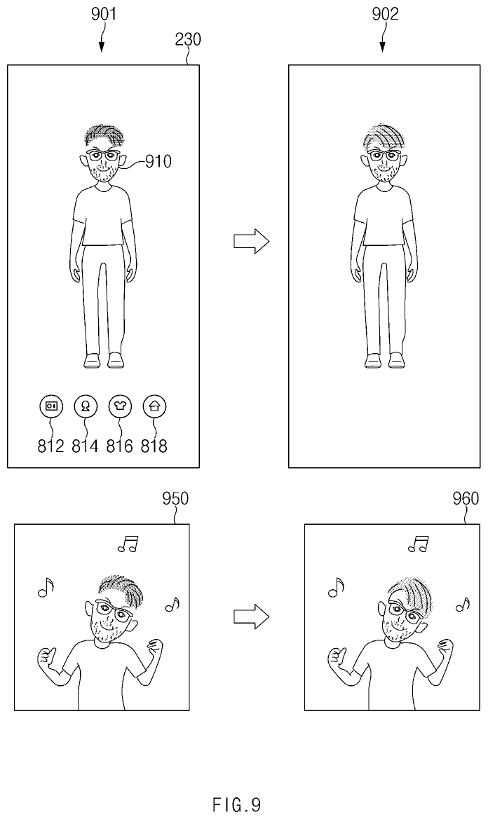

FIG. 9 describes an operating environment of the electronic device 101 generating a second animated image 960, according to various embodiments.

Referring to FIG. 9, in operation 901, the electronic device 101 may display, on the display 230, an avatar 910 based on a 3D object for the avatar 910 stored in the avatar DB 262 and data associated with the 3D object. According to an embodiment, after the 3D object is generated, the electronic device 101 may generate a first animated image 950 indicating a motion of the avatar 910 in a 2D image format, based on the 3D object and resource data.

According to an embodiment, while the avatar 910 is displayed or after the first animated image 950 is generated, the electronic device 101 may receive a user input of editing the 3D object. For example, the electronic device 101 may receive a user input of selecting one of objects 812, 814, 816, and 818 displayed below the avatar 910 on the display 230. The first object 812 may provide an UI for editing a profile of the avatar 910. The second object 814 may provide an UI for editing a hair style or a face of the avatar 910. The third object 816 may provide an UI for editing clothes that the avatar 910 wears. The fourth object 818 may provide an UI for editing an accessory (e.g., glasses) that the avatar 910 wears.

When an appearance of the avatar 910 is changed depending on a user input, in operation 902, the electronic device 101 may display, on the display 230, the avatar 910, the appearance (e.g., a hair style) of which is changed, based on an edited 3D object. For example, the avatar module 251 may change the appearance of the avatar 910 by editing the 3D object depending on the user input. The avatar module 251 may store the edited 3D object and data associated with the 3D object in the avatar DB 262.

According to an embodiment, the electronic device 101 may generate the second animated image 960, in which the appearance of the avatar in the first animated image 950 is changed, by using the edited 3D object. For example, the sticker composing module 252 may generate the second animated image 960 by composing the edited 3D object and resource data used in generating the first animated image 950. In this case, the sticker composing module 252 may load the resource data from the resource DB 264 by using identification information of the avatar 910 (or the 3D object). The electronic device 101 may increase a diversity as the user changes an appearance of an avatar (e.g., 910) in the 3D environment, and may also secure the efficiency of the memory 240 and the compatibility by generating an animated image (e.g., 960) for the appearance-changed avatar. Also, even though the user changes only the appearance of the avatar, the electronic device 101 may change the appearance of the avatar in an animated image indicating a motion of the avatar, thus preventing a mismatch between the avatar 910 expressed three-dimensionally (3D) and the animated image.

According to an embodiment, in response to that the appearance of the avatar 910 is changed, the electronic device 101 may update the first animated image 950 with the second animated image 960 without a user input. For example, the electronic device 101 may compare a time when identification information of the avatar 910 is generated with a time when the 3D object for the avatar 910 is updated. When the time when identification information of the avatar 910 is generated is different from the time when the 3D object for the avatar 910 is updated, the electronic device 101 may generate the second animated image 960 by using the edited 3D object.

According to another embodiment, depending on the user preference, the electronic device 101 may not update the second animated image 960 until an additional user input is received even though the appearance of the avatar 910 is changed.

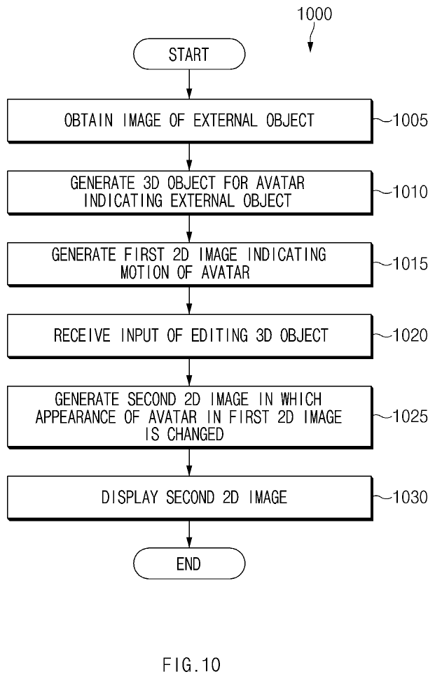

FIG. 10 illustrates an operation flowchart 1000 of the electronic device 101 generating a second animated image, according to various embodiments. Operations illustrated in FIG. 10 may be performed as the processor 220 executes instructions stored in the memory 240.

Referring to FIG. 10, in operation 1005, the processor 220 may obtain an image of an external object (e.g., the user) through the camera 210.

In operation 1010, the processor 220 may generate a 3D object for an avatar (e.g., 910 of FIG. 9) indicating the external object based on the obtained image. For example, the processor 220 may generate the 3D object through the avatar module 251.

In operation 1015, the processor 220 may generate a first 2D image indicating a motion of the avatar based on resource data stored in the memory 240 (e.g., the resource DB 264) and the 3D object. The first 2D image may be an animated image. For example, the processor 220 may compose at least one of animation data, an FG image, a background image, an effect image, or a text, with the 3D object through the sticker composing module 252.

According to an embodiment, the processor 220 may generate the first 2D image in plurality. For example, when there is a history that a 2D image is generated or edited depending on a user input, the processor 220 may generate a plurality of first 2D images based on the history information stored in the memory 240.

In operation 1020, the processor 220 may receive an input of editing the 3D object. For example, the processor 220 may receive a user input of editing at least one of a hair style, a face, a body, clothes, or accessory of the avatar.

In operation 1025, the processor 220 may generate a second 2D image, in which an appearance of the avatar in the first 2D image is changed, based on the edited 3D object. The second 2D image may be an animated image indicating the same motion, the same foreground, the same background, and the same effect as the first 2D image. When a plurality of first 2D images are generated in operation 1015, the processor 220 may generate a plurality of second 2D images.

In operation 1030, the processor 220 may display the second 2D image through the display 230. According to an embodiment, when the processor 220 generates a plurality of second 2D images, the processor 220 may display thumbnails for the plurality of second 2D images. In this case, the processor 220 may display the thumbnails in order based on the user's preference included in the history information.

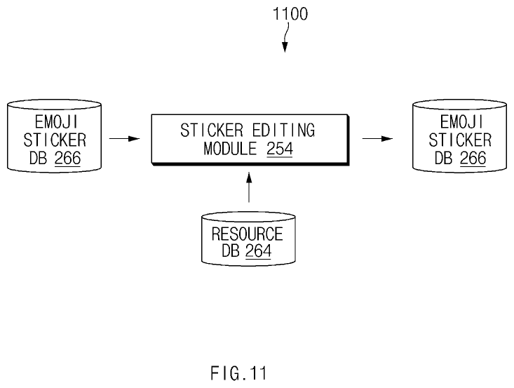

FIG. 11 illustrates an operating environment 1100 of the sticker editing module 254, according to various embodiments.

Referring to FIG. 11, the sticker editing module 254 may edit an animated image previously generated, depending on a user input. For example, the sticker editing module 254 may load an animated image of a 2D format (e.g., AGIF) previously stored in the emoji sticker DB 266. The sticker editing module 254 may add a foreground, a background, an effect, or a text in the animated image by using resource data stored in the resource DB 264, depending on the user input. The sticker editing module 254 may edit an animated image in a 2D environment, and thus, the load of the processor 220 may be reduced.

When the animated image is completely edited, the sticker editing module 254 may store the edited animated image in the emoji sticker DB 266 in a 2D format.

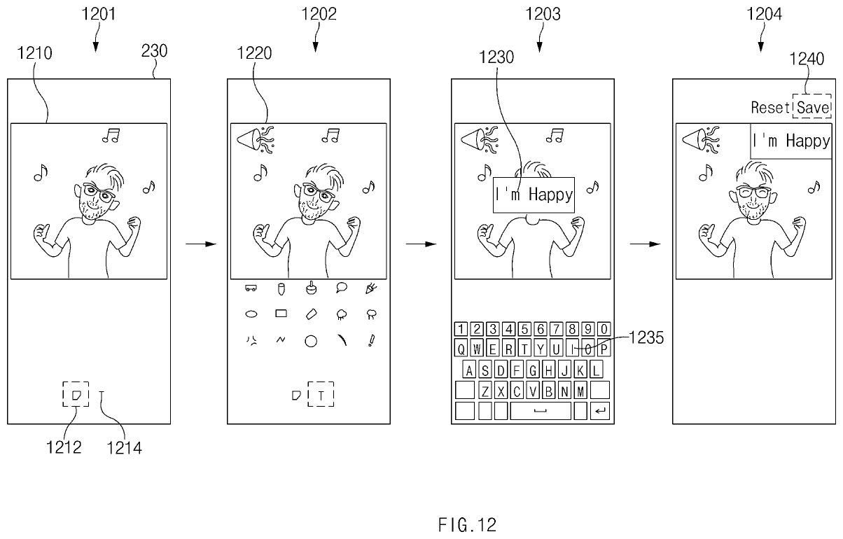

FIG. 12 illustrates an UI for editing an animated image 1210, according to various embodiments. Operations illustrated in FIG. 12 may be performed by the electronic device 101 or may be performed as the processor 220 executes instructions stored in the memory 240.

Referring to FIG. 12, in operation 1201, the electronic device 101 may display the animated image 1210 on at least a partial region of the display 230. According to an embodiment, the electronic device 101 may display objects 1212 and 1214 providing functions for editing the animated image 1210 in a region (e.g., a lower end thereof) except for a region where the animated image 1210 is displayed. The first object 1212 may provide a function capable of adding an effect image. The second object 1214 may provide a function capable of adding a text. Although not illustrated in FIG. 12, the electronic device 101 may further display objects capable of adding a foreground image or a background image.

When a user input of selecting the first object 1212 is received, in operation 1202, the electronic device 101 may add at least one effect image (e.g., 1220), which is selected depending on the user input, to the animated image 1210. A location of the added effect image may be determined depending on the user input.

When a user input of selecting the second object 1214 is received, in operation 1203, the electronic device 101 may add at least one text (e.g., 1230) to the animated image 1210 depending on the user input. The text may be generated, for example, depending on a user input to a virtual keyboard 1235. A location of the added text may be determined depending on the user input.

In operation 1204, the electronic device 101 may store the edition-completed animated image 1210 in response to a user input 1240.

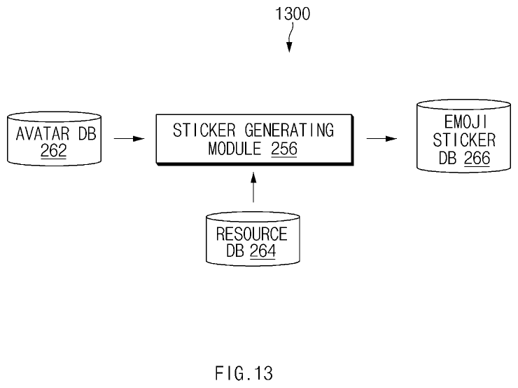

FIG. 13 illustrates an operating environment 1300 of the sticker generating module 256, according to various embodiments.

Referring to FIG. 13, the sticker generating module 256 may generate an animated image depending on a user input. For example, the sticker generating module 256 may load a 3D object stored in the avatar DB 262 based on identification information. Depending on resource data stored in the resource DB 264 and the user input, the sticker generating module 256 may add facial expression or body motion of an avatar indicated by the loaded 3D object or may add a foreground, a background, an effect, or a text. Because kinds of animated images generated by a combination increase as the number of animation data, foreground images, background images, and effect images increases, the sticker generating module 256 may provide the user with a personalized animated image. Also, because the sticker generating module 256 does not need to generate an unnecessary animated image in advance, a storage space of the memory 240 may be secured.

When the animated image is completely edited, the sticker generating module 256 may store the edited animated image in the emoji sticker DB 266 in a 2D format.

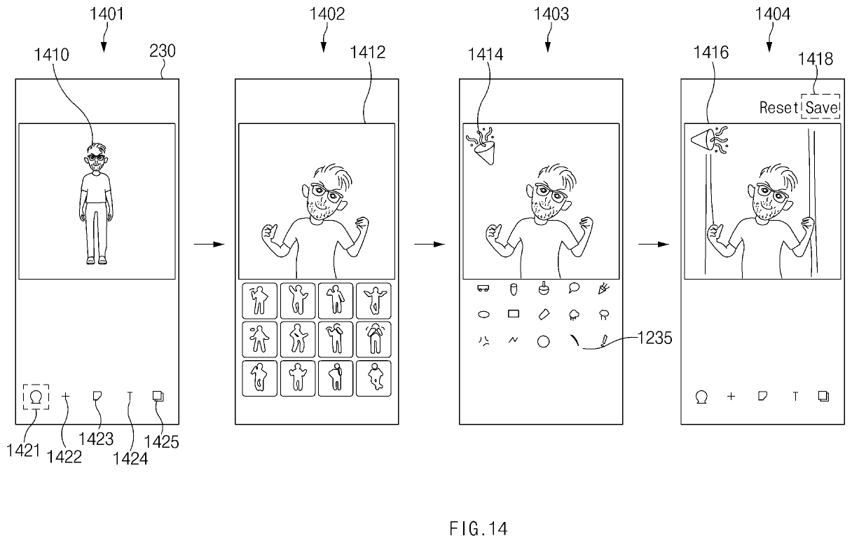

FIG. 14 illustrates an UI for generating an animated image, according to various embodiments. Operations illustrated in FIG. 14 may be performed by the electronic device 101 or may be performed as the processor 220 executes instructions stored in the memory 240.

Referring to FIG. 14, in operation 1401, the electronic device 101 may display an avatar 1410 on at least a partial region of the display 230. According to an embodiment, the electronic device 101 may display objects 1421, 1422, 1423, 1424, and 1425 providing functions for generating an animated image in a region (e.g., a lower end thereof) except for a region where the avatar 1410 is displayed. The first object 1421 may provide a function capable of adding a motion of facial expression of the avatar 1410. The second object 1422 may provide a function capable of adding a motion of a body of the avatar 1410. The third object 1423 may provide a function capable of adding an effect image. The fourth object 1424 may provide a function capable of adding a text. The fifth object 1425 may provide a function capable of adding a background image. Although not illustrated in FIG. 14, the electronic device 101 may further display an object capable of displaying a foreground image.

When a user input of selecting the second object 1422 is received, in operation 1402, the electronic device 101 may display an animated image 1412, which indicates a motion selected depending on the user input, on at least a partial region of the display 230.

When a user input of selecting the third object 1423 is received, in operation 1403, the electronic device 101 may add at least one effect image (e.g., 1414), which is selected depending on the user input, on the animated image 1412. A location of the added effect image may be determined depending on the user input.

In operation 1404, the electronic device 101 may store a selection-completed animated image 1416 in response to a user input 1418.

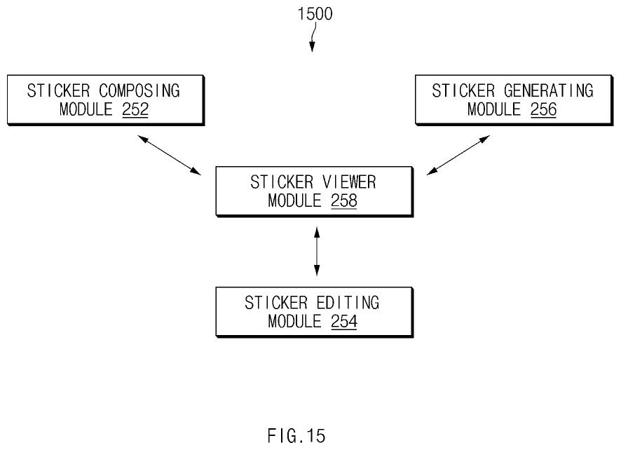

FIG. 15 illustrates an operating environment 1500 of the sticker viewer module 258, according to various embodiments.

Referring to FIG. 15, the sticker viewer module 258 may perform an interface function of calling the sticker composing module 252, the sticker editing module 254, or the sticker generating module 256 such that the user may perform generation, edition, and sharing of an animated image through the electronic device 101.

For example, the sticker viewer module 258 may display a list of avatars through the display 230; in response to a user input of selecting one avatar from the list of avatars displayed, the sticker viewer module 258 may load animated images corresponding to the selected avatar.

For another example, the sticker viewer module 258 may display thumbnails on the display 230 for the purpose of recommending an animated image to the user, and may call the sticker composing module 252 so as to generate an animated image corresponding to a thumbnail selected by the user from among the displayed thumbnails.

For another example, the sticker viewer module 258 may call the sticker generating module 256 for the purpose of generating an animated image from a 3D object.

For another example, the sticker viewer module 258 may call the sticker editing module 254 for the purpose of editing an animated image previously stored.

The sticker viewer module 258 may provide, through the above method, an environment in which the user is capable of generating an emoji sticker conveniently and quickly.

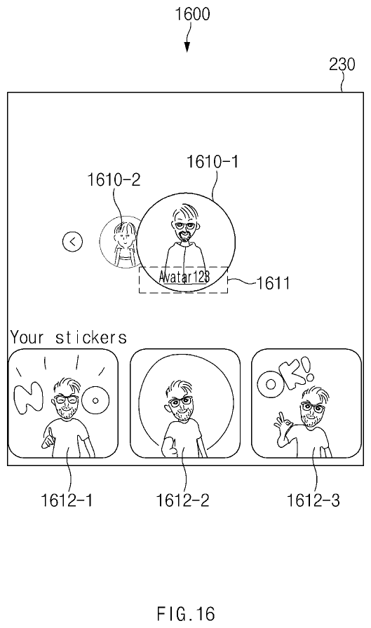

FIG. 16 illustrates a UI 1600 for displaying a thumbnail, according to various embodiments.

Referring to FIG. 16, the electronic device 101 may display a plurality of avatars (e.g., 1610-1 and 1610-2) on the display 230. The electronic device 101 may display a name 1611 for the avatar 1610-1 selected by the user from among the plurality of avatars. According to an embodiment, the electronic device 101 may change the name 1611 depending on a user input.

According to an embodiment, the electronic device 101 may display thumbnails 1612-1, 1612-2, and 1612-3 of animated images for the selected avatar 1610-1. The number of thumbnails and motions of the avatar that the thumbnails indicate are not limited to the example illustrated in FIG. 16.

According to an embodiment, when an animated image for the avatar 1610-1 is not stored in the memory 240 (e.g., the emoji sticker DB 266), the electronic device 101 may display thumbnails of animated images to be recommended to the user. To reduce a time necessary to generate an animated image and the load of the processor 220, the electronic device 101 may display thumbnails before generating an animated image and may generate an animated image corresponding to a thumbnail selected from the displayed thumbnails. According to an embodiment, when there is a history that an animated image is generated or edited depending on a user input, the electronic device 101 may recommend the animated image based on the history information stored in the memory 240.

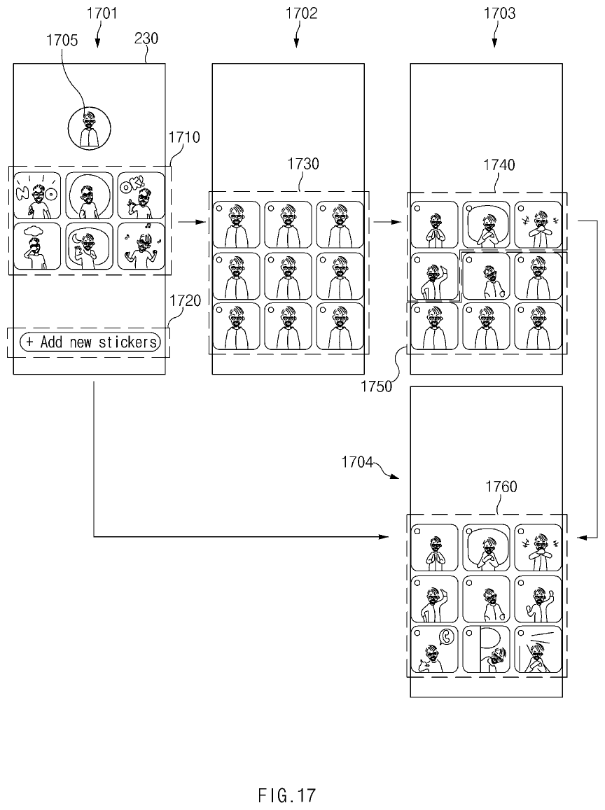

FIG. 17 illustrates an operating environment of the electronic device 101 updating a thumbnail, according to various embodiments.

Referring to FIG. 17, in operation 1701, the electronic device 101 may display thumbnails 1710 of a plurality of animated images for an avatar 1705 on at least a partial region of the display 230. Because a size of a file of thumbnails is small compared to a size of a file of animated images, the electronic device 101 may reduce the load of the processor 220. According to an embodiment, to reduce a time necessary to load the thumbnails 1710, the electronic device 101 may generate thumbnails when the sticker module 250 is in an idle state or a background state.

According to an embodiment, the electronic device 101 may generate an animated image in response to a user input 1720 of requesting addition of an animated image. When the electronic device 101 generates the animated image in response to the user input 1720, a time interval from a time when the user input 1720 is received to a time when thumbnails 1760 for added animated images are displayed may occur depending on the number of animated images to be added and a processing speed of the processor 220. According to an embodiment, the electronic device 101 may display the added thumbnails 1760 simultaneously or sequentially, based on at least one of a time passing from the time when the user input 1720 is received, the number of animated images to be added, or a processing speed of the processor 220.

For example, when the time passing from the time when the user input 1720 is received is smaller than a threshold value, when the number of animated images to be added is smaller than a threshold value, or when the processing speed of the processor 220 is higher than or equal to a threshold value, in operation 1704, the electronic device 101 may display the added thumbnails 1760 at the same time.

For another example, when the time passing from the time when the user input 1720 is received is greater than or equal to the threshold value, when the number of animated images to be added is greater than or equal to the threshold value, or when the processing speed of the processor 220 is lower than the threshold value, in operation 1702, the electronic device 101 may display dummy thumbnails 1730. When some animated images are completely generated, in operation 1703, the electronic device 101 may display thumbnails 1740 of the animated images completely generated, and thumbnails of animated images under generation (or, the generation of which is not completed) may be displayed as dummy thumbnails 1750.

Through the above-described method, the electronic device 101 may notify the user that an operation of generating animated images is being normally performed and may secure the stability of operation.

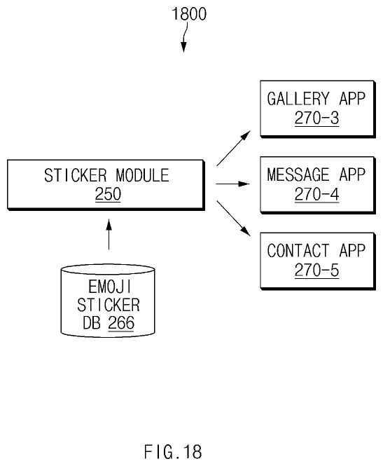

FIG. 18 illustrates an operating environment 1800 of the electronic device 101 for sharing an animated image with any other application, according to various embodiments.

Referring to FIG. 18, the sticker module 250 (e.g., the sticker viewer module 258) may transfer an animated image stored in the emoji sticker DB 266 to any other application (e.g., 270-3, 270-4, or 270-5). In addition to the applications illustrated in FIG. 18, any other application may include various applications installed on the electronic device 101. The electronic device 101 may provide an animated image to any other application and thus may provide an environment in which the user is capable of utilizing the animated image in various manners.

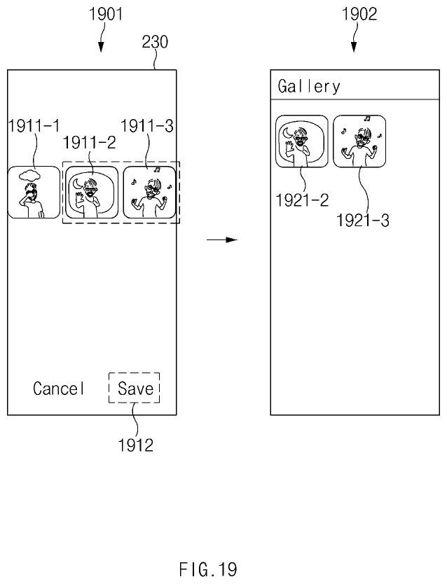

FIG. 19 illustrates an UI for sharing an animated image with a gallery application, according to various embodiments.

Referring to FIG. 19, in operation 1901, the electronic device 101 may receive a user input of selecting at least a part (e.g., 1911-2 and 1911-3) of thumbnails 1911-1, 1911-2, and 1911-3 displayed on the display 230. The electronic device 101 may store animated images corresponding to the selected thumbnails 1911-2 and 1911-3 in a gallery application in response to a user input 1912 of requesting a save for the selected thumbnails 1911-2 and 1911-3. For example, the electronic device 101 may store the animated images in a 2D format (e.g., AFIG). According to an embodiment, the electronic device 101 may store the animated images in a separate folder of the gallery application.

When a user input of executing the gallery application is received, in operation 1902, the electronic device 101 may display the stored animated images 1921-1 and 1921-3.

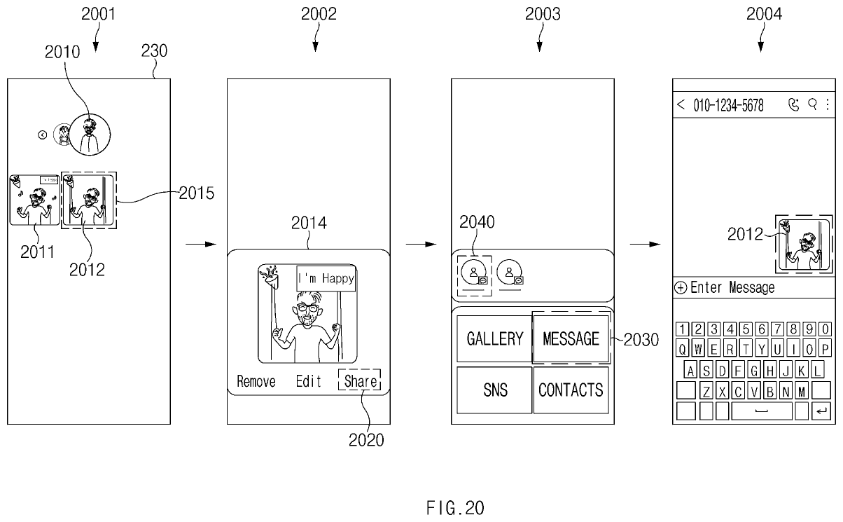

FIG. 20 illustrates an UI for sharing an animated image with a message application, according to various embodiments. FIG. 20 shows an embodiment in which the electronic device 101 shares an animated image with a message application, but the same principle may be applied to any other application (e.g., an SNS application) capable of sharing the content with any other user.

Referring to FIG. 20, in operation 2001, the electronic device 101 may display animated images 2011 and 2012 for an avatar 2010 on the display 230. According to an embodiment, the electronic device 101 may display thumbnails of the animated images 2011 and 2012. The electronic device 101 may receive a user input 2015 of selecting the animated image 2012 of the displayed animated images 2011 and 2012.

In response to the user input 2015, in operation 2002, the electronic device 101 may display a screen 2014 indicating a function (e.g., remove, edit, or share) for the selected animated image 2012 and may receive a user input 2020 of requesting a share of the animated image 2012 through the displayed screen 2014.

In response to the user input 2020, in operation 2003, the electronic device 101 may display a list of applications (e.g., gallery, message, SNS, and contacts) sharing the animated image 2012 and may receive a user input 2030 of selecting a message application. The electronic device 101 may receive a user input 2040 of selecting a counterpart for sharing the animated image 2012.

In response to the user inputs 2030 and 2040, in operation 2004, the electronic device 101 may send the animated image 2012 to an external electronic device. According to an embodiment, the electronic device 101 may send the animated image 2012 in a 2D format.

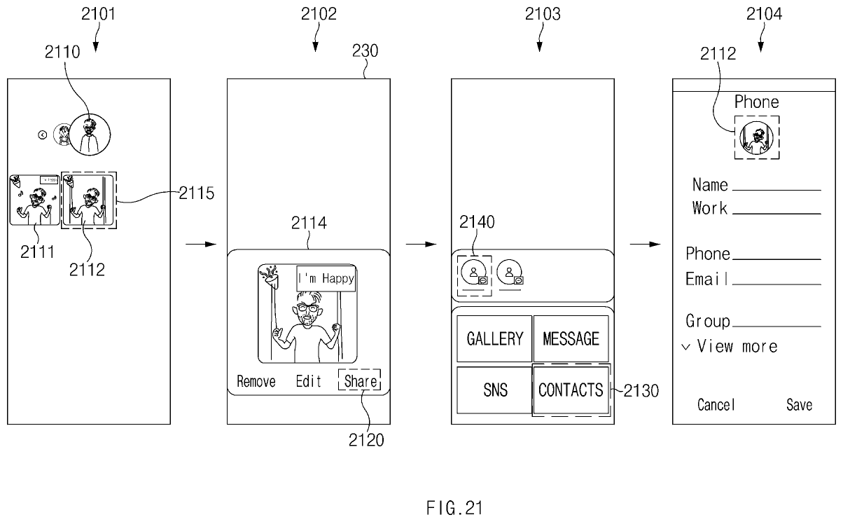

FIG. 21 illustrates an UI for sharing an animated image with a contact application, according to various embodiments.

Referring to FIG. 21, in operation 2101, the electronic device 101 may display animated images 2111 and 2112 for an avatar 2110 on the display 230 and may receive a user input 2115 of selecting the animated image 2112 of the displayed animated images 2111 and 2112.

In response to the user input 2115, in operation 2102, the electronic device 101 may display a screen 2114 indicating a function (e.g., remove, edit, or share) for the selected animated image 2112 and may receive a user input 2120 of requesting a share of the animated image 2112 through the displayed screen 2114.

In response to the user input 2120, in operation 2103, the electronic device 101 may display a list of applications (e.g., gallery, message, SNS, and contacts) sharing the animated image 2112 and may receive a user input 2130 of selecting a contact application. The electronic device 101 may receive a user input 2140 of selecting a counterpart for registering the animated image 2112.

In response to the user inputs 2130 and 2140, in operation 2104, the electronic device 101 may register the animated image 2112 as a photo of a contact of the selected counterpart.

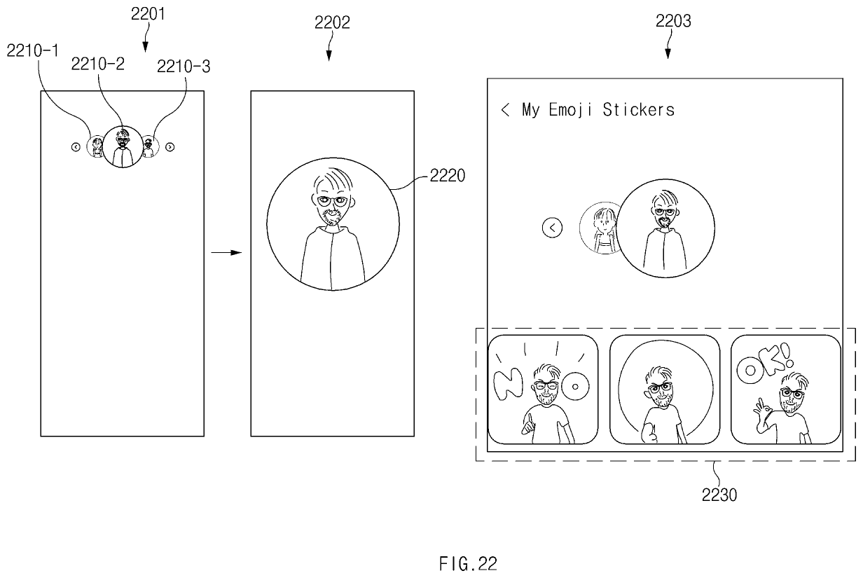

FIG. 22 describes an operating environment of the electronic device 101 generating an animated image when the animated image is not stored in a memory, according to various embodiments.

According to an embodiment, due to a user input or execution of any other application (e.g., incoming a call), while the electronic device 101 (e.g., the sticker composing module 252) generates animated images, the sticker module 250 may be terminated. When the sticker module 250 is terminated, a 3D object may be stored in the memory 240, but an animated image may not be stored therein. When the animated image for the 3D object is not stored in the memory 240, the electronic device 101 may generate an animated image by using the sticker composing module 252.

In operation 2201, the electronic device 101 may receive a user input of selecting (or calling) an avatar 2210-2 of a plurality of avatars 2210-1, 2210-2, and 2210-3. In response to the user input, the electronic device 101 may determine whether an animated image for the avatar 2210-2 is present in the memory 240 (e.g., the emoji sticker DB 266).

When a stored animated image is absent, in operation 2202, the electronic device 101 may generate animated images for the avatar 2210-2. According to an embodiment, the electronic device 101 may display, on the display 230, an UI 2220 indicating that the animated images are being generated.

When the animated images are generated, in operation 2203, the electronic device 101 may display thumbnails 2230 of the generated animated images.

As described above, an electronic device (e.g., 101 of FIG. 1) may include a camera (e.g., 210 of FIG. 2), a display (e.g., 230 of FIG. 2), a processor (e.g., 220 of FIG. 2) that is operatively connected with the camera and the display, and a memory (e.g., 240 of FIG. 2) that is operatively connected with the processor and stores animation data associated with a motion. The memory may store instructions that, when executed, cause the processor to obtain, through the camera, an image associated with an external object, to generate a three-dimensional (3D) object for an avatar indicating the external object, based on the obtained image, to display, through the display, a first two-dimensional (2D) image generated based on the animation data and the 3D object, to receive a first input of editing the 3D object, to generate a second 2D image in which an appearance of the avatar in the first 2D image is changed based on the first input thus received, and to display, through the display, the second 2D image.

According to an embodiment, the instructions may cause the processor to generate a plurality of frames by composing the 3D object edited based on the first input and the animation data, and to generate a plurality of images indicating the third 2D image by composing the plurality of frames.

According to an embodiment, the instructions may cause the processor to sample the plurality of frames based on the number of frames corresponding to at least one of a message application executed by the electronic device or a location where a connection of the electronic device is made, and to generate the plurality of images by composing the sampled frames.

According to an embodiment, the memory may further store at least one of a background image or an effect image, and the instructions may cause the processor to receive a second input of editing at least one of the 3D object, the animation data, the background image, or the effect image, to generate a third 2D image in which at least one of an appearance of the avatar indicated by the first 2D image, a motion of the avatar, a background, or an effect is changed based on the second input thus received, and to display the third 2D image through the display.

According to an embodiment, the instructions may cause the processor to identify whether a background image selected based on the second input is a black background image, and to generate the third 2D image based on the 3D object and a white background image instead of the selected background image, when the selected background image is the black background image.

According to an embodiment, the instructions may cause the processor to store the second 2D image in a gallery application, to execute the gallery application in response to a third input of executing the gallery application, and to display the second 2D image through the display when the gallery application is executed.

According to an embodiment, the electronic device may further include a wireless communication circuit (e.g., 260 of FIG. 2) that performs wireless communication with an external electronic device, and the instructions may cause the processor to execute a message application in response to a fourth input of executing the message application, and to send, through the wireless communication circuit, the second 2D image to the external electronic device in response to a fifth input of sending the second 2D image.

According to an embodiment, the memory may further store history information which is based on the first input, and the instructions may cause the processor to generate a plurality of the first 2D images based on the animation data, the 3D object, and the history information, and to display thumbnails for the plurality of the first 2D images through the display.

According to an embodiment, the instructions may cause the processor to receive a sixth input of calling the avatar, to identify that the first 2D image is absent from the memory, to generate the first 2D image based on the three-dimensional image and the animation data, and to display the first 2D image through the display.

As described above, a method of an electronic device may include obtaining an image associated with an external object (e.g., 1005 of FIG. 10), generating a three-dimensional (3D) object for an avatar indicating the external object, based on the obtained image (e.g., 1010 of FIG. 10), displaying a first two-dimensional (2D) image generated based on animation data stored in the electronic device and the 3D object (e.g., 1015 of FIG. 10), receiving a first input of editing the 3D object (e.g., 1025 of FIG. 10), and displaying a second 2D image in which at least a portion of the first 2D image is changed based on the first input thus received (e.g., 1030 of FIG. 10).

According to an embodiment, the displaying of the second 2D image may include generating a plurality of frames by composing the 3D object and the animation data in response to the first input, and generating a plurality of images indicating the second 2D image by composing the plurality of frames.

According to an embodiment, the generating of the plurality of images may include sampling the plurality of frames based on the number of frames corresponding to at least one of a message application executed by the electronic device or a location where a connection of the electronic device is made, and generating the plurality of images by composing the sampled frames.

According to an embodiment, the method may further include storing the second 2D image in a gallery application, executing the gallery application in response to a second input of executing the gallery application, and displaying the second 2D image when the gallery application is executed.

According to an embodiment, the method may further include executing a message application in response to a third input of executing the message application, and sending the second 2D image to an external electronic device in response to a fourth input of sending the second 2D image.

According to an embodiment, the method may further include storing history information which is based on the first input, generating a plurality of first 2D images based on the animation data, the 3D object, and the history information, and displaying thumbnails for the plurality of first 2D images.

As described above, an electronic device (e.g., 101 of FIG. 1) may include a camera (e.g., 210 of FIG. 2), a display (e.g., 230 of FIG. 2), a processor (e.g., 220 of FIG. 2) that is operatively connected with the camera and the display, and a memory (e.g., 240 of FIG. 2) that is operatively connected with the processor and stores animation data associated with a motion. The memory may store instructions that, when executed, cause the processor to obtain, through the camera, an image associated with an external object, to generate a three-dimensional (3D) object for an avatar indicating the external object, based on the obtained image, to generate a first 2D image indicating a motion of the avatar, based on the 3D object and the animation data, and to display the first 2D image through the display.

According to an embodiment, the instructions may cause the processor to generate a plurality of frames by composing the 3D object and the animation data, and to generate the first 2D image by composing the plurality of frames.

According to an embodiment, the instructions may cause the processor to sample the plurality of frames based on the number of frames corresponding to at least one of a message application executed by the electronic device or a location where a connection of the electronic device is made, and to generate the first 2D image by composing the sampled frames.

According to an embodiment, the instructions may cause the processor to receive a first input of editing the 3D object, to generate a second 2D image in which an appearance of the avatar in the first 2D image is changed based on the first input, and to display the second 2D image through the display.

According to an embodiment, the electronic device may further include a wireless communication circuit configured to perform wireless communication with an external device. The instructions may cause the processor to execute a message application in response to a second input of executing the message application, and to send, through the wireless communication circuit, the first 2D image to the external electronic device in response to a third input of sending the first 2D image.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a camera;
a display;
a processor operatively connected with the camera and the display; and
a memory operatively connected with the processor, and configured to store animation data associated with a motion,
wherein the memory stores instructions that, when executed, cause the processor to:
obtain, through the camera, an image associated with an external object;
generate a three-dimensional (3D) object for an avatar representing the external object based on the obtained image;
display, through the display, a first two-dimensional (2D) image generated based on the animation data and the 3D object;
receive a first input for editing the 3D object;
generate a second 2D image in which an appearance of the avatar in the first 2D image is changed based on the received first input; and
display, through the display, the second 2D image.

2. The electronic device of claim 1, wherein the instructions cause the processor to:
generate a plurality of frames by composing the 3D object and the animation data in response to the first input; and
generate a plurality of images representing a third 2D image by composing the plurality of frames.

3. The electronic device of claim 2, wherein the instructions cause the processor to:
sample the plurality of frames based on a number of frames corresponding to at least one of a message application executed by the electronic device or a location where a connection of the electronic device is made; and
generate the plurality of images by composing the sampled frames.

4. The electronic device of claim 1, wherein:
the memory further stores at least one of a background image or an effect image, and
the instructions cause the processor to:
receive a second input of editing at least one of the 3D object, the animation data, the background image, or the effect image;
generate a third 2D image in which at least one of an appearance of the avatar indicated by the first 2D image, a motion of the avatar, a background, or an effect is changed based on the received second input; and
display the third 2D image through the display.

5. The electronic device of claim 4, wherein the instructions cause the processor to:
identify whether a background image selected based on the second input is a black background image; and
when the selected background image is the black background image, generate the third 2D image based on the 3D object and a white background image instead of the selected background image.

6. The electronic device of claim 1, wherein the instructions cause the processor to:
store the second 2D image in a gallery application;
execute the gallery application in response to a third input of executing the gallery application; and
when the gallery application is executed, display the second 2D image through the display.

7. The electronic device of claim 1, further comprising:
a wireless communication circuit configured to perform wireless communication with an external electronic device,
wherein the instructions cause the processor to:
execute a message application in response to a fourth input of executing the message application; and
transmit, through the wireless communication circuit, the second 2D image to the external electronic device in response to a fifth input of sending the second 2D image.

8. The electronic device of claim 1, wherein:
the memory further stores history information that is based on the first input, and
the instructions cause the processor to:
generate a plurality of the first 2D images based on the animation data, the 3D object, and the history information; and
display thumbnails for the plurality of the first 2D images through the display.

9. The electronic device of claim 1, wherein the instructions cause the processor to:
receive a sixth input of calling the avatar;
identify that the first 2D image is absent from the memory;
generate the first 2D image based on the 3D object and the animation data; and
display the first 2D image through the display.

10. A method of an electronic device, comprising:
obtaining an image associated with an external object;
generating a three-dimensional (3D) object for an avatar representing the external object, based on the obtained image;
displaying a first two-dimensional (2D) image generated based on animation data stored in the electronic device and the 3D object;
receiving a first input for editing the 3D object; and
displaying a second 2D image in which at least a portion of the first 2D image is changed based on the received first input.

11. The method of claim 10, wherein the displaying of the second 2D image includes:
generating a plurality of frames by composing the 3D object and the animation data in response to the first input; and
generating a plurality of images representing the second 2D image by composing the plurality of frames.

12. The method of claim 11, wherein the generating of the plurality of images includes:
sampling the plurality of frames based on a number of frames corresponding to at least one of a message application executed by the electronic device or a location where a connection of the electronic device is made; and
generating the plurality of images by composing the sampled frames.

13. The method of claim 10, further comprising:
storing the second 2D image in a gallery application;
executing the gallery application in response to a second input of executing the gallery application; and
when the gallery application is executed, displaying the second 2D image.

14. The method of claim 10, further comprising:
executing a message application in response to a third input of executing the message application; and
transmitting the second 2D image to an external electronic device in response to a fourth input of sending the second 2D image.

15. The method of claim 10, further comprising:
storing history information that is based on the first input;
generating a plurality of first 2D images based on the animation data, the 3D object, and the history information; and
displaying thumbnails for the plurality of first 2D images.

16. The method of claim 10, further comprising:
storing at least one of a background image or an effect image,
receiving a second input of editing at least one of the 3D object, the animation data, the background image, or the effect image;
generating a third 2D image in which at least one of an appearance of the avatar indicated by the first 2D image, a motion of the avatar, a background, or an effect is changed based on the received fifth input; and
displaying the third 2D image through the display.

17. The method of claim 16, further comprising:
identifying whether a background image selected based on the fifth input is a black background image; and
when the selected background image is the black background image, generating the third 2D image based on the 3D object and a white background image instead of the selected background image.

18. The method of claim 10, further comprising:
receiving a sixth input of calling the avatar;
identifying that the first 2D image is absent from a memory;
generating the first 2D image based on the 3D object and the animation data; and
displaying the first 2D image through the display.

19. A non-transitory computer readable medium containing instructions that when executed cause a processor to:
store animation data associated with a motion;
obtain an image associated with an external object;
generate a three-dimensional (3D) object for an avatar representing the external object based on the obtained image;
display a first two-dimensional (2D) image generated based on the animation data and the 3D object;
receive a first input for editing the 3D object;
generate a second 2D image in which an appearance of the avatar in the first 2D image is changed based on the received first input; and
display the second 2D image.

20. The non-transitory computer readable medium of claim 19, wherein the instructions when executed cause the processor to:
generate a plurality of frames by composing the 3D object and the animation data in response to the first input; and
generate a plurality of images representing a third 2D image by composing the plurality of frames.
